(19) United States
(12) Patent Application Publication
(10) Pub. No.: US 2007/0084124 A1
(43) Pub. Date: Apr. 19, 2007

(54) Snap-in insert component for sash windows

(76) Inventor: Steven F. Brooker, Marietta, OH (US)

Correspondence Address: CESARI AND MCKENNA, LLP, 88 BLACK FALCON AVENUE, BOSTON, MA, 02210, US

(21) Appl. No.: 11/251,032

(22) Filed: Oct. 14, 2005

(51) Int. Cl. E05D 13/00

(52) U.S. Cl. 49/456; 49/504

(57) ABSTRACT

A snap-in insert component for non-permanently closing an access opening fabricated near the top of the jamb of a sash window. Locating the access opening near the top of the window jamb avoids air infiltration problems in the window that result when the opening is located below the upper end of the lower sash of the window. The insert component, when inserted in the access opening, provides a bearing surface for a tilt latch on the lower sash when the sash is raised to the point of the access opening. This allows the sash to be raised all the way to the top of the window frame without experiencing un-desired movement in the in and out direction. The insert component can be readily re-moved and re-inserted in the field as the need arises. Because the insert component essentially completely fills the access opening, the appearance of the window is improved.

### BACKGROUND OF THE INVENTION

### Field of the Invention

This invention relates generally to sash windows, and more particularly, to a snap-in insert component for access openings in the frames of tiltable sash windows.

### Background Information

Conventional single hung sash windows and double hung sash windows include, respectively, one and two movable window sashes, slidably mounted in a window frame. The sashes move in guide grooves formed in the jambs of the frame. Typically, there are balance components that travel with each sash in the interior space defined by the jamb of the window frame. These balance components can become jammed, worn or loose from use over time, giving rise to the need for replacement in the field. Access openings have been fabricated in each jamb of the window frame to provide a means for removing the balance components from the jamb for replacement in the field. These access openings must typically be wider than the guide grooves in the jambs to allow the balance components to pass through the openings.

Many conventional single hung sash windows and double hung sash windows have tiltable sashes. Tiltable sashes typically include a tilt latch at each side of at least one, usually the upper end of the sash. Each tilt latch includes a latch arm including a portion that normally projects into its associated guide groove in the jamb, and that bears against the opposed surfaces of the jamb that define the groove as the sash is moved relative to the jamb. The latch arm can be manually moved inwardly to release the upper end of the sash from its associated guide groove. This allows the upper end of the sash to be tilted away from the jamb for cleaning and other purposes.

Historically, the access openings mentioned above, for providing access to and removal of the balance components in the jambs, were located at a point in the jambs below the upper end of the lower window sash when closed, where the tilt latches of that sash would not reach. The access openings at these elevations could not be covered or filled with an insert component as the cover or insert component would interfere with the travel of the balance components in the jambs as the sash was moved. The access openings were thus often left uncovered, detracting from the appearance of the window. They were also disadvantaged in that, because of their width, they broke a sealing surface for weatherstripping between the lower sash when closed and the jamb of the frame. This allowed air to infiltrate through the window frame into the interior space of the wall in which installed.

To avoid these disadvantages, some window designers have located the access openings at a point near the top of the jambs, beyond the range of travel of the balance components in the jambs. Sash stops, which are easily removed when access to the balance components inside the jambs is required, are often used to cover and hide the access openings, thus improving the appearance of the window. The sash stops also serve to limit the upward travel of the lower sash, preventing the tilt latches from reaching the access openings. Because of the greater width of the access openings compared to the guide grooves, the lower sash would experience undesired movement in the in and out direction if its tilt latches are allowed to reach the access openings.

The sash stop solution, however, is not an acceptable one for windows which are classified as egress windows. In egress windows, it is preferred, and often required, that the lower sash have as much upward travel in the window frame as possible. As a result, the sash stops can not be used, requiring that the access openings near the top of the jambs be left exposed. This again generally detracts from the appearance of the windows. Also, with the sash stops removed, the tilt latches on the lower sash can reach the access openings when the sash is raised to the point of the openings. This results in the undesired sash movement in the in and out direction mentioned above.

### SUMMARY OF THE INVENTION

Accordingly, the present invention aims generally to provide an improved sash window design.

More particularly, it is an object of the present invention to provide an improved insert component for an access opening in the frame of a sash window which normally covers and closes the opening, improving the appearance of the window, and which can be readily removed when necessary to provide access to the interior of the frame.

It is another object of the invention to provide an insert component for an access opening that is located at the top of the window jamb, at a point that is beyond the range of travel of the balance components in the jamb.

It is still another object of the invention to provide an insert component of the type described which can be snapped into the access opening and which provides a bearing surface for tilt latches on the sash when the sash is opened and moved to the location of the insert component and access opening.

These and other objects of the invention will be better understood by those skilled in the art from the detailed description of illustrative embodiments of the invention which appears below and the accompanying drawings.

Briefly, a conventional sash window includes a frame having left and right side window jambs which define guide grooves for vertically movable window sashes. The window jambs are hollow and typically enclose balance components for each movable sash which facilitate their movement and which travel with the sashes over a limited range of movement. Access openings are fabricated in the jambs to provide a means for removing and replacing the balance components in the field. The access openings are wider than the guide grooves to allow the balance components to pass through them during replacement.

In accordance with the present invention, the access openings in a sash window of the above-described type are located near the top of the jambs of the window, and a snapin insert component non-permanently closes each access opening. Each insert component has a generally c-shaped cross-section including a base portion, first and second side portions extending from opposite ends of the base portion and first and second tabs extending inwardly at the ends of the respective side portions. The side portions extend outwardly at an angle slightly greater than ninety degrees to the plane of the base portion. The insert component is fabricated from a material such as plastic that is somewhat flexible so that the side portions may be flexed inwardly as the component is pushed into the access opening. Additionally, a lip is formed on the outside surface of each side portion of the insert component. The lips bear against the jamb adjacent the access opening as the insert component is pressed into the opening, causing the side portions to flex inwardly toward one another. When the insert component is fully inserted in the opening, the side portions snap outwardly and the lips engage against the inside surfaces of the jamb wall around the access opening to retain the insert component in place.

The inwardly extending tabs on the insert component are designed to conform generally in shape and size to the access opening, so that when the component is inserted in the opening, the opening is neatly and essentially completely closed by the insert. With the component so inserted, the outside surfaces of its tabs are essentially coplanar with the surfaces of the jamb facing the sash on each side of the guide groove, while the inside surfaces of its side portions are essentially coplanar with the bearing surfaces of the guide grooves. The insert component may be readily removed from the access opening when necessary simply by flexing its side portions inwardly toward one another as the component is pulled from the opening.

By locating the access openings at the top of the window jambs, the window can achieve better air infiltration performance because the continuity of the sealing surface of the sash weatherstripping is maintained when the window is closed. The access openings are also at a point that is beyond the range of travel of the balance components in the jambs. By filling the access openings with the insert component of the invention, support for the sash tilt latches is provided even when the sash is raised to the location of the access openings, and the window appearance is significantly improved.

### BRIEF DESCRIPTION OF THE DRAWINGS

For a fuller understanding of the objects, features and advantages of the invention, reference should be made to the following detailed description and accompanying drawings, in which:

FIG. 1 is a front perspective view of a double hung vinyl sash window incorporating a snap-in insert component embodied in accordance with the invention;

FIG. 2 is a fragmentary perspective view on a larger scale showing the upper right hand corner area of the window of FIG. 1 and an access opening to the interior space defined by the jamb of the window;

FIG. 3 is a perspective view of a snap-in insert component embodied in accordance with the invention;

FIG. 4 is a cross-sectional view of the insert component of FIG. 3 taken along the line 4-4 shown in FIG. 3; and

FIG. 5 is a fragmentary perspective view similar to that of FIG. 2 showing the upper right hand corner area of the window of FIG. 1 with its lower sash raised to the point of the insert component and access opening in the window.

### DETAILED DESCRIPTION OF ILLUSTRATIVE EMBODIMENTS

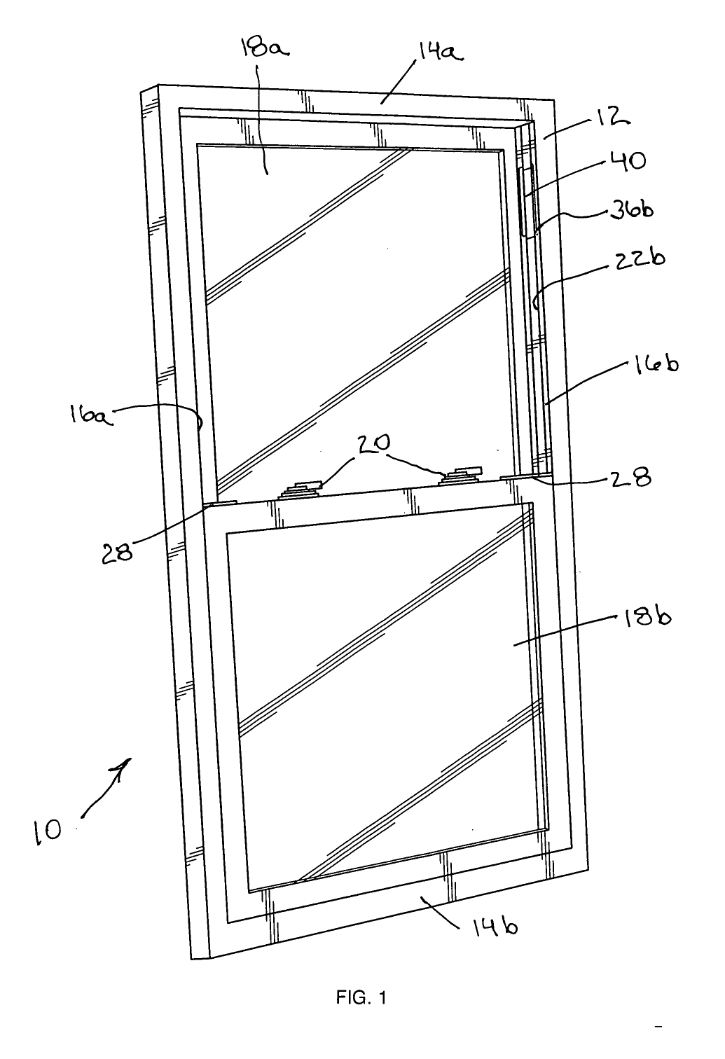

Referring now to FIG. 1 of the drawings, there is shown a double hung sash window 10 embodied in accordance with the invention. The window 10 includes a frame 12 that has upper and lower generally horizontal cross members 14a and 14b and left and right side members or jambs 16a and 16b. Upper and lower window sashes 18a and 18b are slidably mounted for movement upwardly and downwardly in the frame 12. The sashes 18a and 18b are shown in their fully closed positions in FIG. 1. Conventional locking devices 20 can be manually operated to lock the sashes 18a and 18b in their fully closed positions.

The frame 12 and its structural members and the non-transparent structural members of each window sash 18a and 18b are preferably made of plastic such as extruded polyvinylchloride. The structural members of the frame are typically hollow and include, in their interior spaces, conventional balance components (not shown) that facilitate the sliding motion of the sashes 18a and 18b relative to the frame 12. Portions of the interior spaces of the structural members may also be filled with insulation. The transparent portions of the sashes 18a and 18b are typically double paned thermal glass.

Each jamb 16a and 16 a of the window frame 12 includes a pair of parallel guide grooves that extend vertically between the upper and lower cross members 14a and 14b and in which the sashes 18a and 18b slidably engage. Because of the angle of the view of FIG. 1, only the right hand side guide groove 22b for the lower sash 18b is visible therein.

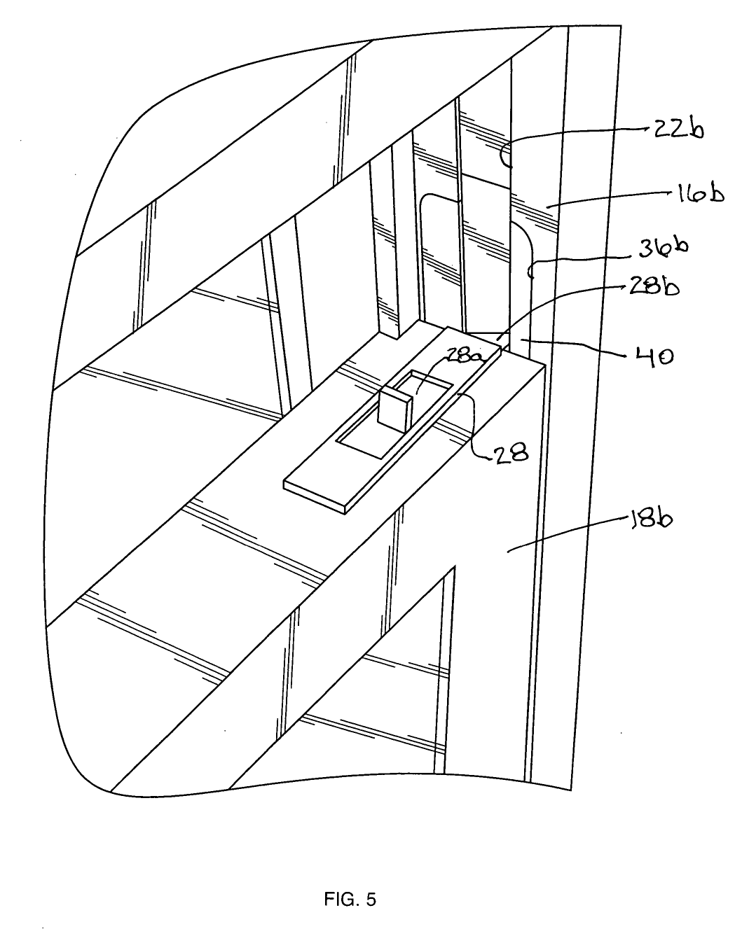

A pair of tilt latches 28 are located at opposite sides of the upper end of the sash 18b. The tilt latch 28 on the right hand side of the sash 18b is best seen in the expanded view of FIG. 5 of the drawings. The tilt latch 28 includes a latch arm 28a with a projection 28b that engages in the guide groove 22b. The latch arm projection 28b bears against the inside surface of the jamb 16 a that defines the guide groove 22b and holds the sash 18b in place relative to the jamb 16 a. An identical tilt latch 28 (not shown in FIG. 5, but shown generally in FIG. 1) is provided on the left hand side of the lower sash 18b. The latch arm 28a of the tilt latch 28 can be manually moved inwardly to disengage the projection 28b from the guide groove 22b. A similar action on the left hand side tilt latch 28 frees the upper end of the sash 18b from its guide grooves and allows the sash 18b to be tilted outwardly from the frame 12 for cleaning and other purposes.

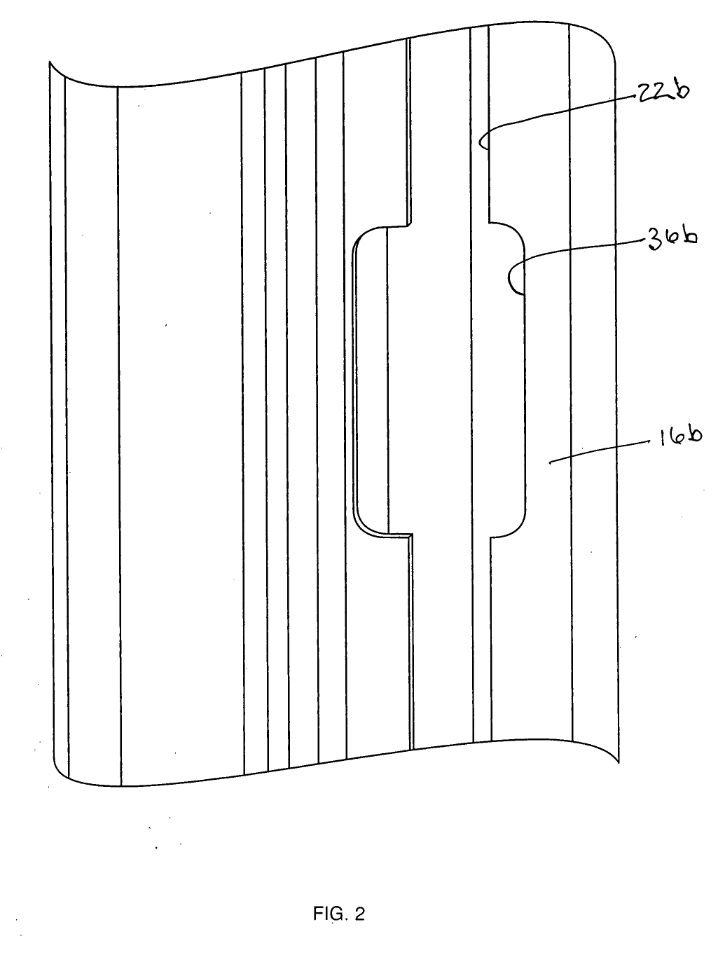

An access opening 36b is fabricated near the top of the right side jamb 16 a. The opening is non-permanently closed with a snap-in insert component 40 embodied in accordance with the invention. The access opening 36b is shown in more detail in the expanded view of FIG. 2. The access opening 36b is intended to provide access to the interior space defined by the structural members of the frame 12. As noted previously, one reason for this access is to remove and replace damaged or worn balance components that travel in the interior spaces of the frame 12 with the movement of the sashes 18a and 18b.

To allow the balance components to pass through the opening, the access opening 36b is typically wider than the guide groove 22b. The opening 36b may also be asymmetrical in shape, as shown in FIG. 2, having a width to the interior of the guide groove 22b (generally to the left in FIG. 2) that is somewhat greater than its width to the exterior of the guide groove 22b (generally to the right in FIG. 2). An identical access opening 36a (not shown) may be fabricated in the left side jamb 16a of the window 10 to provide a means for removing and replacing balance components located in the interior space of the left side jamb 16a.

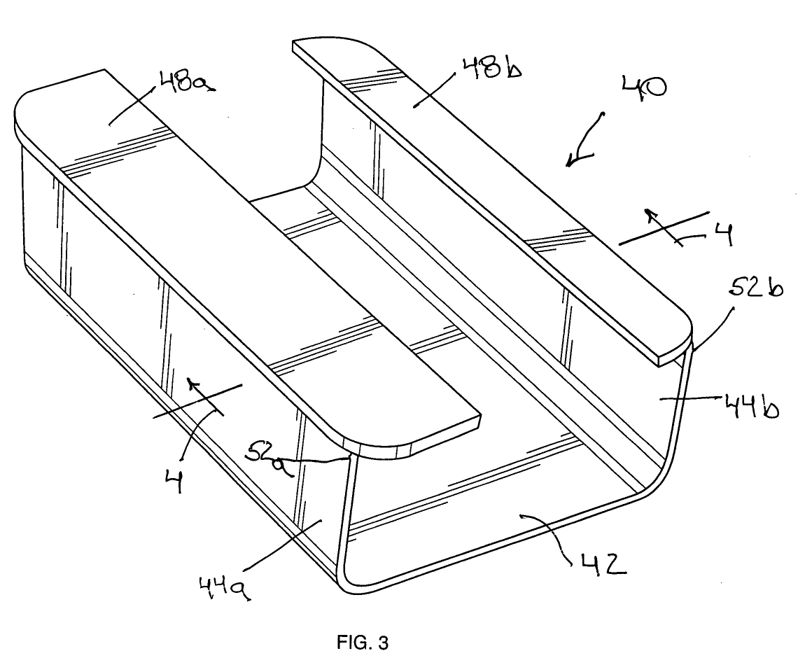

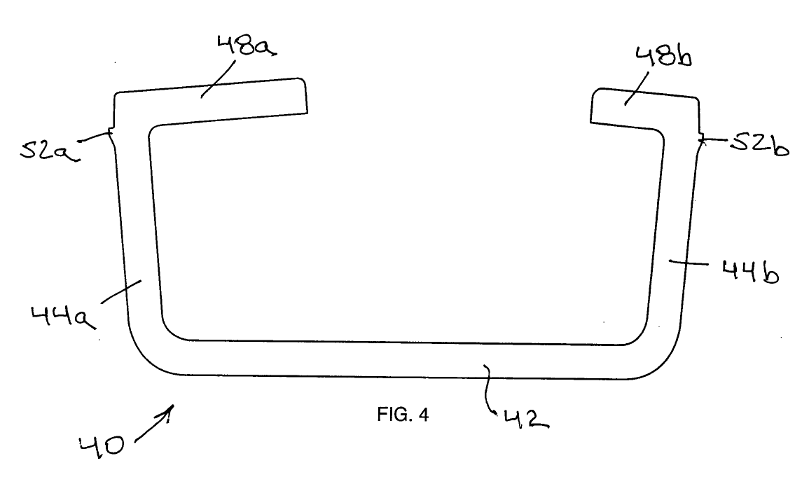

FIG. 3 shows the insert component 40 removed from the access opening 36b. FIG. 4 is a cross-section of the insert component 40 of FIG. 3 showing its generally c-shaped configuration.

The insert component 40 includes a base portion 42, first and second side portions 44a and 44b extending upwardly and outwardly from opposite ends of the base portion 42, and first and second tabs 48a and 48b extending inwardly from the ends of the side portions 44a and 44b, respectively, spaced away from the base portion 42.

As best seen in FIG. 4, when the insert component 40 is removed from the access opening 36b and in an unstressed, unflexed condition, the side portions 44a and 44b are flared outwardly so that they extend at an angle somewhat greater than ninety degrees (90°) to the plane of the base portion 42. In the preferred embodiment, the side members 44a and 44b extend at an angle of about ninety-five degrees (95°) to the plane of the base portion 42. The tabs 48a and 48b are essentially perpendicular to the side portions 44a and 44b, respectively. Because of the outward flaring of the side portions 44a and 44b, the tabs 48a and 48b are not parallel to the plane of the base portion 42 but rather deviate therefrom by an angle of about five degrees (5°).

A pair of lips 52a and 52b are formed on the tab end outside surface of each of the side portions 44a and 44b, near the top or tab end thereof. The sides of the lips 52a and 52b facing downwardly or toward the base portion 42 are tapered, while the sides of the lips 52a and 52b facing upwardly or toward the tabs 48a and 48b are relatively flat. The flat surfaces of the lips 52a and 52b are spaced downwardly from the upper surface of the tabs 48a and 48b by a distance that is approximately equal to the thickness of the wall of the jamb 16 a adjacent the access opening 36b.

The tabs 48a and 48b have an area and shape that generally conform to the area and shape of the portions of the access opening 36b that extend beyond the width of the guide groove 22b. The side portions 44a and 44b of the insert component 40 are spaced from one another by a distance, and have a height above the base portion 42, that conform to the width and depth of the guide groove 22b, respectively. As a result of these dimensional and shape conformances, the tabs 48a and 48b are generally coplanar with the jambs 16 a and fill the access opening 36b essentially completely when the insert component 40 is fully inserted in the access opening 36b. Additionally, the inside surfaces of the side portions 44a and 44b and base portion 42 are generally coplanar with the opposed surfaces of the jamb that define the guide groove 22b. This conformance is best illustrated in FIG. 5 of the drawings, which shows the insert component 40 fully inserted in the access opening 36b.

In the preferred embodiment, the insert component 40 is fabricated by injection molding from an ABS plastic. The base portion 42, side portions 44a and 44b and tabs 48a and 48b have a wall thickness of about 0.075 inch. The overall length of the base portion 42 is about 2.0 inches, and its overall width is about 1.22 inch. The lips 52a and 52b have a maximum height above the outside surfaces of the side portions 44a and 44b of about 0.010 inch.

Because of the outward flaring of the side portions 44a and 44b, and the presence of the tapered lips 52a and 52b on their outside surfaces, the side portions 44a and 44b of the insert component 40 flex inwardly toward one another as the component 40 is pressed into the access opening 36b. The tapered surfaces of the lips 52a and 52b bear against the portions of the jamb 16 a adjacent the access opening 36b to facilitate this flexing. When the insert component 40 is fully inserted in the access opening 36b, and the flat surfaces of the lips 52a and 52b clear the inside surfaces of the jamb 16 a adjacent the access opening 36b, the side portions 44a and 44b snap outwardly to a point where they are essentially perpendicular to the base portion 42 of the component 40. The flat surfaces of the lips 52a and 52b engage against the inside surfaces of the jamb 16 a adjacent the access opening 36b to retain the insert component 40 firmly in the place in the opening. The tendency of the side portions 44a and 44b to want to return to their flared positions assists in retaining the insert component 40 in place.

As seen in FIG. 5, with the insert component 40 in place in the window 10, the sash 18b may be raised to the extreme top of the frame 12 without concern about the presence of the access opening 36b there. More specifically, the inside surfaces of the side portions 44a and 44b of the insert component 40 provide bearing surfaces for the tilt latch 28 as the sash 18b is raised to the location of the access opening 36b. As a result, there is no undesired movement of the sash 18b in the in and out direction at that point.

The insert component 40 may be easily removed from the access opening 36b when necessary by squeezing the tabs 48a and 48b toward one another until the lips 52a and 52b clear the walls of the jamb 16 a, and pulling the component 40 from the opening 36b. The insert component 40 may be snapped back into the access opening 36b after the necessary repairs have been made.

It can thus be seen that the objects set forth above, including those made apparent from the preceding detailed description, are efficiently attained with my invention. Those skilled in the art will appreciate that various modifications may be made to the specific embodiments described herein without departing from the scope of the invention. For example, although the access opening 36b in the window 10, and the tabs 48a and 48b on the insert component 40, are shown above as being asymmetrical with respect to the guide groove 22b, they could be symmetrical as well. In double hung windows, access openings can be provided for both of the moveable sashes, in both the left and right side jambs. The insert component 40 could readily be adapted to non-permanently close an access opening in an aluminum window as well.

It is thus intended that all matter contained in the above description and shown in the accompanying drawings be interpreted as illustrative and not in a limiting sense, with the following claims defining the true scope of the invention.

What is claimed is:

1. An insert component for non-permanently closing an access opening in a frame of a window, the frame including spaced apart jambs, each jamb defining a hollow interior space and including opposed surfaces defining a guide groove, the window including at least one window sash slidably mounted for movement in the guide grooves of the jambs, the access opening being through a portion of the opposed surfaces of at least one of the jambs defining the guide groove for providing access to the interior space of the jamb, the insert component having a generally c-shaped cross-section including a base portion, first and second spaced apart side portions extending outwardly from opposite ends of said base portion, and first and second tabs extending inwardly from said first and second side portions, respectively, and spaced from said base portion, said side portions and said tabs of said insert component substantially filling the access opening when said component is inserted therein.

2. The insert of claim 1 in which said first and second side portions enable said insert component to be snapped into the access opening.

3. The insert component of claim 2 in which said first and second side portions are flared outwardly relative to said base portion, and are flexed inwardly toward one another as said insert component is inserted in the access opening.

4. The insert component of claim 2 further including a lip protruding from an outside surface of each of said first and second side portions, said lips being adapted to engage an interior surface of the jamb when said component is filly inserted in the access opening to retain said component in place.

5. The insert component of claim 4 in which each of said lips on each of said side portions includes a tapered surface facing toward said base portion and a generally flat surface facing toward said tabs, said tapered surfaces on said lips being adapted to bear against the jamb adjacent the access opening as said component is pressed into the access opening, causing said side portions to flex inwardly toward one another, said flat surfaces on said lips being adapted to engage the interior surface of the jamb when said component is fully inserted in the access opening.

6. The insert component of claim 1 in which said base portion, said side portions and said tabs are formed as an integral unit.

7. The insert component of claim 1 in which said base portion, said side portions and said tabs are formed as an integral unit from plastic.

8. The insert component of claim 3 in which said side portions are flexed inwardly toward one another to remove said insert component from the access opening.

9. A sash window comprising:
a frame including a pair of spaced apart jambs;
each jamb having an upper end and a lower end, defining a hollow interior space and including opposed surfaces defining a guide groove;
at least one window sash slidably mounted for movement in the guide grooves of the jambs;
at least one access opening formed through a portion of the opposed surfaces of at least one of the jambs defining the guide groove therein, at a location near the upper end of the jamb, said access opening for providing access to the interior space of the jamb;
an insert component adapted to be snap-fitted in said access opening, said insert component having a generally c-shaped cross section and including:
a) a base portion,
b) first and second spaced apart side portions extending outwardly from opposite ends of said base portion, and
c) first and second tabs extending inwardly from said first and second side portions, respectively, and spaced from said base portion,
said side portions and said tabs of said insert component substantially filling said access opening when said component is inserted therein.

10. The window of claim 9 further including at least one tilt latch carried by said sash adjacent the guide groove in one of the jambs, said tilt latch having a movable latch arm with a first position in which it projects into the guide groove and holds said sash relative to the jamb and a second position in which said latch arm is disengaged from the guide groove to allow said sash to be tilted away from the jamb, at least one of said first and second side portions of said insert component providing a bearing surface for said tilt latch when said latch arm is in its first position and said sash is raised to the location of said access opening.

11. The window of claim 9 in which said side portions of said insert component include lips which contact the jamb adjacent said access opening as said component is pressed into said access opening, causing said side portions to flex inwardly toward one another, and which engage an interior surface of the jamb when said access component is fully inserted in said access opening to retain said component in place.

12. The window of claim 9 in which said insert component is formed as an integral unit from plastic.
